(19) United States
(12) Patent Application Publication
(10) Pub. No.: US 2008/0225762 A1
(43) Pub. Date: Sep. 18, 2008

(54) MUNICIPAL SAFETY INTEGRATED INFRASTRUCTURE NETWORK FOR PROVIDING CONNECTIVITY TO PUBLIC AGENCIES, OFFICES AND FIXED/MOBILE INFRASTRUCTURE ELEMENTS

(76) Inventor: Mark Patrick Soliman, Melbourne, FL (US)

Correspondence Address: BEUSSE WOLTER SANKS MORA & MAIRE, P. A., 390 NORTH ORANGE AVENUE, SUITE 2500, ORLANDO, FL, 32801, US

(21) Appl. No.: 12/044,910

(22) Filed: Mar. 7, 2008

Related U.S. Application Data
(60) Provisional application No. 60/893,427, filed on Mar. 7, 2007.

(51) Int. Cl. H04B 7/00

(52) U.S. Cl. 370/310

(57) ABSTRACT

A communications network for making information available to a one or more government agencies. The network comprises antennas on publicly operated facilities, transceivers for sending messages to and receiving messages from one or more of the antennas, routers responsive to messages received at the antennas for routing the messages on a network path to a desired destination, the routers also responsive to messages from a source on the communications network for routing the messages to antennas and wherein the routers are controlled to route the messages to a desired destination, the desired destination determined by the existence of a situation involving users who can benefit from the information in the message.

This patent application claims the benefit under Section 119(e) of the provisional patent application assigned Application No. 60/893,427 filed on Mar. 7, 2007.

### FIELD OF THE INVENTION

The present invention relates to an apparatus and methods for a municipal safety/integrated infrastructure network (MSII Network) focusing on a connectivity network for a variety of public agencies and services.

### BACKGROUND OF THE INVENTION

After a decade of exposure to the logistical issues public agencies experience in establishing their own connectivity networks, observing the expansive benefits public infrastructure and agencies experience with their own wide area network, and understanding the need for a common MSII Network platform to permit civilization to address both domestic and international issues, the inventor has decided to commit his experience and civil infrastructure/development expertise to serve the many required regional launches of this undertaking to create a national, even global, shield. The ideas expressed in this patent application are tools toward a successful development, acquisition and deployment of such a network for the benefit of all municipalities.

### BRIEF DESCRIPTION OF THE DRAWINGS

The present invention can be more easily understood and the advantages and uses thereof more readily apparent when the following detailed description of the invention is read in conjunction with the figures wherein:

FIG. 1 illustrates an MSII Network according to the present invention.

FIG. 2 illustrates the public agencies that may be connected to the Network of the present invention.

FIGS. 3A and 3B illustrate details of the MSII Network.

### DETAILED DESCRIPTION OF THE INVENTION

Before describing in detail exemplary apparatuses and methods for achieving a successful MSII Network it should be observed that the present invention resides primarily in a novel and non-obvious combination of elements and method steps. So as not to obscure the disclosure with details that will be readily apparent to those skilled in the art, certain conventional elements have been presented with lesser detail, while the drawings and the specification describe in greater detail other elements pertinent to understanding the invention.

The following embodiments are not intended to define limits as to the structure or methods of the invention, but only to provide exemplary constructions. The described embodiments are permissive rather than mandatory and illustrative rather than exhaustive.

### Overall Description of the Network

Generally, the Municipal Safety Integrated Infrastructure (MSII) Network of the present invention comprises a network of hardwired (including electrical conductors and fiber-optic cables), mesh-type, point-to-point-wireless, point-to-point wired and earth-space communications technologies. The transmitters/receivers (transceivers) can be mounted on/in public facilities for receiving communication signals from and transmitting signals to a plurality of users, including mobile, portable and fixed users. The MSII Network thus provides connectivity between a plurality of users. In one embodiment the users comprises members of government agencies. The user signals received at each transceiver (e.g., a mesh-type wireless receiver, a hardwire/fiber-optic connection or a localized point-to-point wireless receiver) are supplied to a routing station or router located, for example, at local buildings, publicly-operated facilities, infrastructure facilities and mobile command centers. The connectivity infrastructure between the signal source and the routing station is considered LEVEL 1. Vehicular traffic routes and existing infrastructure components may form a skeletal backbone for the LEVEL 1 network infrastructure.

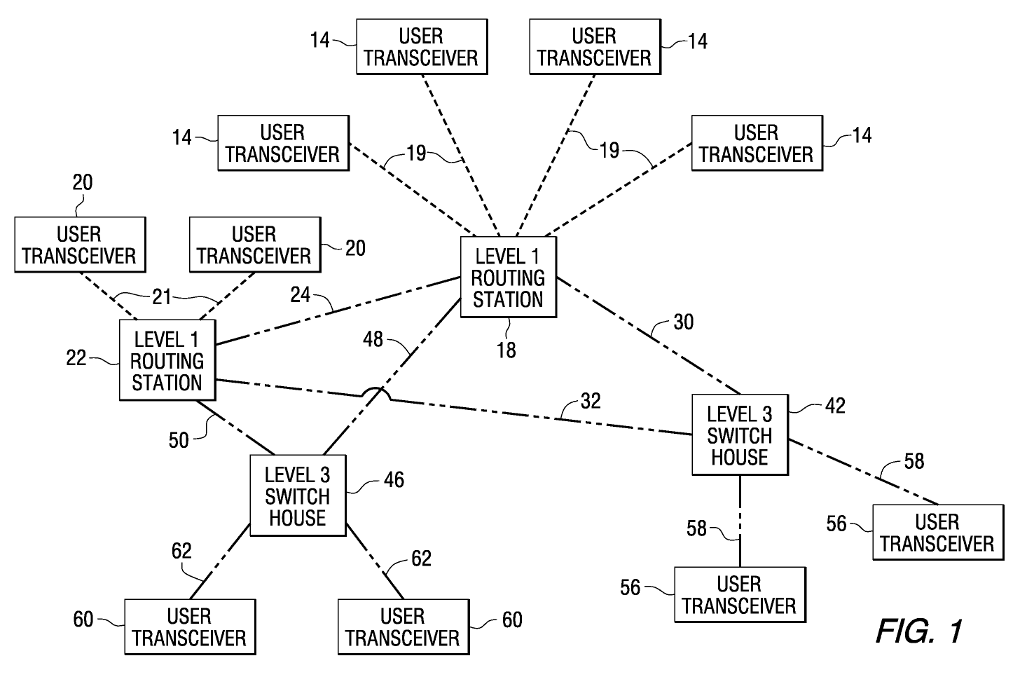

FIG. 1 illustrates an embodiment of an MSII Network including LEVEL 1 (and LEVEL 3) routers, routing stations or switch houses for connecting a plurality of user transceivers 14 to a LEVEL 1 routing station 18 through signal paths 19. User transceivers 20 also communicate with a LEVEL 1 routing station 22 through signal paths 21. The LEVEL 1 routing stations 18 and 22 are connected by a LEVEL 2 interconnect 24. The users operating the user transceivers 14 and 20 comprise fixed users, portable users and mobile users. The switch houses comprise internet protocol routers, telephone-type circuit-switched switches or any other signal/message switching devices.

From the exemplary LEVEL 1 routing stations 18 and 22 the communications signals travel over a respective LEVEL 2 interconnect 30 or 32 (see FIG. 1) to a LEVEL 3 routing station, switch house or router 42. Thus as can be seen, this embodiment illustrates LEVEL 1 and LEVEL 3 routers or switch houses, with LEVEL 2 interconnects connecting LEVEL 1 and LEVEL 3 routers. Signals from the LEVEL 1 routing stations 18 and 22 reach a LEVEL 3 switch house 46 through respective LEVEL 2 interconnects 48 and 50. User transceivers 56 connect to the LEVEL 3 routing station 42 through signal paths 58 and user transceivers 60 connect to the LEVEL 3 routing station 46 through signal paths 62.

Although the FIG. 1 embodiment appears to suggest fixed signal routes and paths, the MSII Network 10 is in fact more fluid and dynamic than it appears. For example, users 14 can connect to either the LEVEL 1 routing stations 18 or 22 depending on the user's location and the ability to close a signal link to the one of the routing stations 18 and 22. Certain of the communications links, especially for fixed users, are hard wired and thus cannot be easily changed. Generally, the messages conveyed over the signal routes are in the form of electrical or optical signals and the signal routes comprise point-to-point wired or wireless, switched wired, switched wireless, satellite, optical links, internet protocol links or the world wide web. The signal paths can be secure or open. Signal paths also contemplate broadcast capabilities to a known or determined group of users.

Signals received at one of the LEVEL 1 routing stations may be routed through a LEVEL 3 routing station to reach another LEVEL 1 routing station to reduce signal traffic on the LEVEL 1 portion of the MSII Network.

Although the users 54/56 providing messages to the LEVEL 3 router 42/46 in FIG. 1 appear similar to the users 14/20 providing messages to the LEVEL 1 routing station 18/22, there is generally an access and/or data hierarchy associated with the LEVEL 1-LEVEL 3 distinction. Some of the LEVEL 3 users may be identical, in terms of their position in the access hierarchy, to LEVEL 1 users, while other LEVEL 3 users occupy a higher level in the hierarchical tree. As applied to government users, interagency agreements may control access to the various levels of signals traveling through the LEVEL 1 and LEVEL 3 routing stations.

The connectivity infrastructure that allows the LEVEL 1 routing stations to reach beyond the LEVEL 1 users is generally considered a LEVEL 2 interconnect structure. The LEVEL 2 connectivity infrastructure provides LEVEL 3 agencies with access to data received at the LEVEL 1 routing stations either directly thru data signals received from LEVEL 1 routing stations or through data signals received from another LEVEL 3 routing station as described below. LEVEL 3 agencies have access to data supplied by other LEVEL 3 agencies through the interconnects to other LEVEL 3 routing stations.

As the MSII Network grows and fewer world-wide-web connection points are utilized at the LEVEL 1 routing stations, switch houses may be added to route signals to out-of-local-area LEVEL 1 recipients on the MSII network. A connectivity infrastructure comprising regional communication switch houses to the next level or layer of connectivity is considered LEVEL 3. The interconnect to a LEVEL 3 routing station may comprise hardwire/fiber-optic or wireless point-to-point connections, between switch houses or from switch houses to long range signal transmitters such as earth-to-satellite stations or long range hardwire/fiber-optic stations then back to the LEVEL 3 switch house.

Therefore, signals travel from and to users according to the priority of the various defined levels of the connectivity infrastructure as defined in the message that is being carried over the network or as determined by the nature of a situation (e.g., an emergency situation) that the users are engaged in and for which the users are utilizing the MSII Network. For example, a signal can be transmitted from its source over the LEVEL 1 portion of the MSII Network 10 to a receiver also on LEVEL 1 with or without passing through the LEVEL 2 interconnect and without passing through a LEVEL 3 infrastructure element. If a LEVEL 3 switch house also houses a LEVEL 1 routing station then the interconnect between LEVEL 1 and LEVEL 3 (referred to herein as a LEVEL 2 interconnect) may in this example be a simple hardwire between the two levels of routing devices. If the LEVEL 1 routing station is not located at the LEVEL 3 switch house, then LEVEL 2 interconnect can comprise any of the other interconnection devices available to form a network.

Actual applications of the network of the present invention depend on a variety of government agency-specific requirements and agreements (that define the LEVEL 1 users, LEVEL 2 interconnects and LEVEL 3 users), physical characteristics of an area and legal and practical mechanisms associated with data access. But the various levels of connectivity infrastructure identified herein establish a relative order of operation to address an anticipated variety of interconnection conditions.

As LEVEL 3 connectivity infrastructure is established regionally and long range hardwire/fiber-optic stations are established, a LEVEL 4 connectivity infrastructure will be realized. The LEVEL 4 connectivity comprises the earth-to-satellite stations and/or other long range hardwire/fiber-optic stations. LEVEL 5 connectivity infrastructure may be the same as LEVEL 4, although LEVEL 4 may be within a specific country and LEVEL 5 may be within a different country.

The transmission levels of the MSII Network require secure transmission and unauthorized intercept capabilities. Not only does this patent address the technical aspects of this MSII network, it also addresses process/operation logic and alarm capabilities. For instance, certain information from certain public agencies will be routed not just according to the technical routing capabilities, but also depending on the regulations/agreements of the agencies involved and the priority of the information, Thus the message routes are time-dynamic (emergencies, natural or man-made are typically assigned the highest priority) and scenario-dynamic. The recipients can also determine the time when the message will be distributed to the recipients. This flexibility ensures that the right people can communicate directly with the right people, clearly and concisely, at an appropriate hierarchical level and at the right time. Messages can also be simultaneously broadcast to a plurality of people, generally for the benefit of public safety. Each scenario's options will be addressed according to agency specific needs and as interoperability opportunities across a series of agencies are defined and/or developed. The following paragraphs generally describe each transmission levels' interoperability with a brief example of pubic agencies and infrastructure utilized.

### Transmission Network

In one embodiment wireless communications in the MSII Network utilize a series of frequencies in the higher bands such as the 4.9 GHz Public Safety frequency up thru the 5.0 ranges and beyond as-needed. This Network will also interoperate with the existing 800 MHz and 2.5 GHz public frequencies currently utilized to maximize all communication infrastructures already in place since they each have their own technical advantages as shown throughout the following sections. The MSII Network has various levels of public connectivity as described in detail below.

### LEVEL 1 Connectivity Infrastructure

The LEVEL 1 connectivity infrastructure encompasses any transmission/device/signal from a user or source to a LEVEL 1 routing station, including the source and routing station. The connectivity infrastructure comprises mesh or point to point wired and wireless connectivity, hardwire and fiber optic line connections, or a combination of these connection techniques, in a series configuration or a single mode of each. LEVEL 1 connectivity infrastructure consists of receivers and/or transmitters mounted on the following public infrastructure elements to either transmit data sourced from the infrastructure and/or data transmissions from other sources:
1. Traffic posts
2. Light posts
3. Communication towers
4. Water towers
5. Sewage lift stations
6. Sewage treatment plants
7. Drinking water sources/well houses
8. Drinking water supply and/or treatment systems
9. Publicly operated buildings (departments, courts, schools, shelters, arenas, VA hospitals, etc.) (Generally publicly operated buildings and structures are owned, operated or leased by a government agency for providing a benefit to the public.)
10. Bridges
11. Border fences
12. Tunnels
13. Roadway signage
14. Flag posts
15. Buses (both public mass-transit and school)
16. Emergency vehicles (police, fire, ambulance, swat, etc.)
17. Publicly operated vehicles
18. Trains/mass transit devices
19. Perimeter fences
20. Water meters
21. Ocean going containers
22. Shipping trucks/trailers
23. Shipping & private vessels
24. Publicly operated marine vessels
25. Cell phones
26. Car and people counters
27. Bomb sniffers

LEVEL 1 data transmissions/messages can be created by any of the following devices:
1. Wireless cards
2. Wireless phones & radios
3. Wireless modems (either fixed or vehicle mounted)
4. Wireless transceivers/transmitters (mesh-type or local point-to-point) mounted on one of the above listed infrastructure components
5. Hardwire (including fiber optic) modems
6. Transceivers for operating over a fiber-optic network

LEVEL 1 data transmissions comprise one of the following types of information signals:
1. Voice
2. Data
3. Video

Transmission of LEVEL 1 data will terminate at routing stations located at:
1. Publicly operated buildings consisting of, but not limited to the following:
   Police, Fire & Ambulance headquarters and/or stations
   Public utility headquarters and/or stations
   City, county, and borough-operated buildings
2. Public infrastructure consisting of, but not limited to the following locations
   Key traffic intersections equipped with a backup power supply
   Strategically located public infrastructure elements such as elevated bridges, dams, tunnel access points, communication towers, water towers, etc.

Actual locations of antennas on publicly operated buildings and publicly operated routing stations will be based on actual thru-put demands of specific agencies, topography, building/structure physical characteristics and security/access controls. Secure private locations may be utilized for routing stations as necessary.

LEVEL 1 communications will integrate network infrastructure elements across all agencies to improve existing public services thru interoperability among agencies. For example, intelligent traffic systems can interoperate with agencies such as fire, police and ambulance to reduce response times while increasing safety by continuously locating vehicles (with or without a GPS system) transmitting quickest route information to the vehicle and controlling traffic signals at intersections as the emergency vehicle approaches. Localized sensors or GPS can determine the vehicle location. These techniques and elements also reduce maintenance and accident rates.

The management and operating hardware/software of specific network levels can either be based at the appropriate agency and routing station, also serving as a localized command and security station, or at a common communications switch location, both with remote access capabilities by authorized users. Fixed public security infrastructure devices can also, for example, transmit video data to routing stations or mobile points as planned based on scenarios defined by individual agencies to best suit their needs (i.e. using video recognition software and setting certain alarm/routing conditions and scenarios based on staff and locations such as the nearest officer responding to a public park safety matter with a partner viewing the video, past and real time simultaneously).

Fixed existing infrastructure such as bridge scouring monitors, seismic detectors, water supply systems, sewage pumping stations and treatment plants, waterway level and weather monitors can also be connected to the LEVEL 1 portion of the MSII Network with access by the appropriate agency such as utilities, weather bureau or waterways, for example.

Local agencies will have the ability to broker private services such as a child-tracking system for parents of young children and vehicle monitoring and locating. Patient medical records can be transmitted over the MSII Network to emergency vehicles or to command posts set up at accident sites. These availability of such services to use the MSII Network promotes the successful growth of any private enterprises offering such services, while increasing public revenue to pay for the services offered, all increasing our quality of life. Other private uses may be identified, however, the actual use of these services will be based on security and user requirements as well as guidelines established by the public frequency license that may govern portions of the network. Various public agencies and municipalities can establish interoperability agreements to determine data to be exchanged between the agencies and to permit the service to extend beyond jurisdictional boarders both for private and public uses.

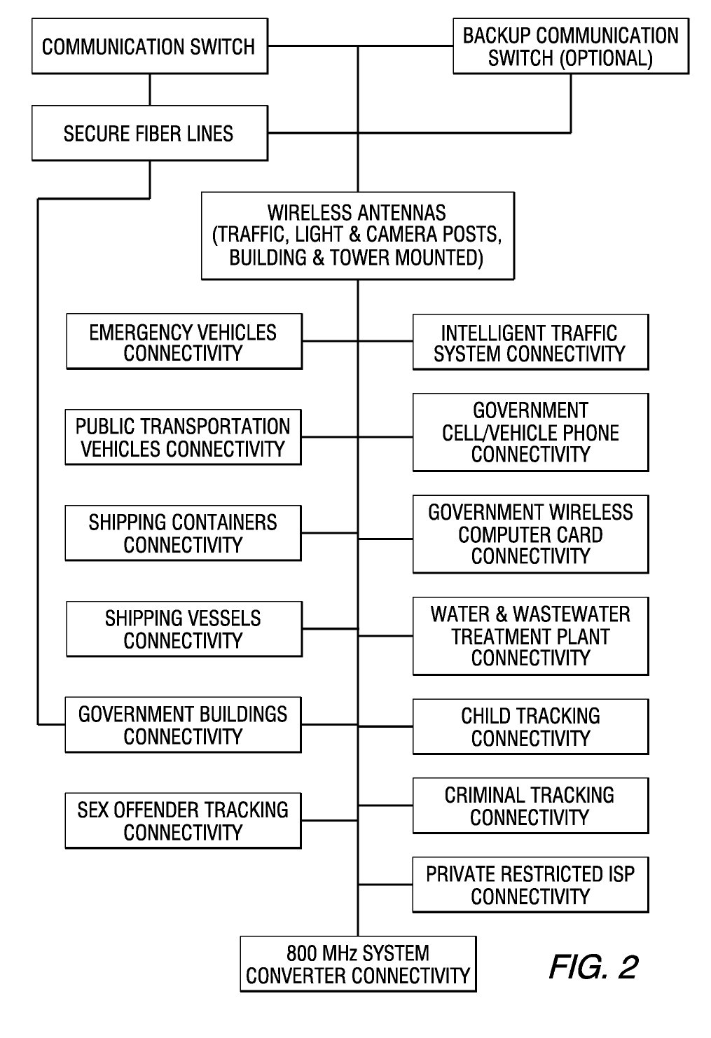

Each network aspect will be tailored by and for a specific agency's needs. This patent will focus on the transmission connectivity and relative interoperability capabilities of the MSII Network. FIG. 2 illustrates the major elements of the MSII Network of the present invention in block diagram form. The following sections describe in detail how each element of this MSII Network will be connected.

Examples of LEVEL 1 data transmissions include data received from emergency and service vehicles, process control systems, SCADA systems and voice/data systems from the following types of agencies and devices:
Public utilities data from sewage lift stations; sewage treatment plants; drinking water well houses; drinking water supplies and or treatment systems
Public facilities data from public pools, parking lots and buildings with automated monitors/controls
Public facilities data from buildings occupied by government agencies
Schools and colleges for security data with a direct link to police headquarters
Parks & Recreation data from traffic flow sensors and environmental condition monitoring stations.
Roadways, bridges and tunnels data from traffic sensors, electronic signage, surveillance cameras, base scouring monitors/depth sensors, water level sensors, current weather and environmental condition monitors, operational stations, and traffic data from the same monitors used by all level of emergency responding agencies. Local or regional plans may define connectivity protocols and priorities to ensure the right agency staff are communicating at the right times in the event of an emergency. Each agency has the necessary data (e.g., number of vehicles in a tunnel during a certain time interval) so the interpretability of all sensed data can be simultaneously analyzed by a variety of public agencies. This effort will address unique emergency-orientated conditions swiftly for the benefit of municipal safety.
Police, fire and ambulance vehicles are integrated with the traffic's infrastructure, at superb connectivity data rates, especially while traveling along roadways. Data such as a situational report, medical records held by a private entity, industrial/commercial hazardous area plans, location update maps, live aerial shots from a helicopter, records of parties involved in a matter, video feeds, etc. can be transmitted en-route responsive to a responder's specific requests or by broadcast from a real-time situation report from the appropriate agency.
Transportation authority for access to data such as live traffic counts, ocean going container movements, environmental (including bomb detectors) and visual monitors.
Police for tracking ID cards carried by sex offenders in the vicinity of schools or criminals with warrants detected by public area sensors.
Police, fire, and parents for child tracking abilities via public area sensors.
Public transportation locators and integration of bus-routes with traffic for reduced maintenance and fuel consumption, real-time arrival estimates posted at bus stops for increased usability.
Screen views can be shared during real-time discussions and conference calls so each agency can concurrently see the data and avoid interpretation delays. The data transmitted can include individual computer mouse movements so everyone is looking at the same data as key decisions are considered or agreed upon. Agencies will work side-by-side using the same assets and tools simultaneously. Common operational platforms are securely linked to incorporate data such as equipment asset lists so public staff can efficiently search other regional assets automatically out of communicable accounting software programs for example coupled with last public location detection for the vicinity. This will help maximize community interoperability and disaster response capabilities by locating and mobilizing the right resources efficiently and effectively to address a matter at hand.

All signals can be transmitted from the source to the routing station and vice-versa by both automated and manually operated devices. Video and voice can be provided in the form of data. Also, the signal can pass through several LEVEL 1 routing stations enroute to a LEVEL 1 destination.

### LEVEL 2 Connectivity Infrastructure

The LEVEL 2 connectivity infrastructure encompasses any signal between a LEVEL 1 routing station and another LEVEL 1 routing station (also referred to as a switch house) any final out-of-LEVEL 1-network destination. This can be accomplished using any type of wireless connectivity, hardwire and fiber optical line connections or a combination thereof. LEVEL 2 connectivity infrastructure can also be mobile on a sub mesh-receiver basis to service existing well proven localized communications systems, especially such as the 800 MHz frequency digital radio systems so emergency personnel can readily integrate into the MSII Network. This will allow the signal to be received from a transponder at a mobile local command vehicle and transmitted through the MSII Network to allow other agencies to learn details of the situation and respond accordingly if needed. The following are examples of the LEVEL 2 connectivity infrastructure and operating agencies. All agencies are connected to a regional switch house using any of the various communications technologies described herein or know in the art.

The following authorities are examples of public participants that will have access through inter-agency operability and/or ownership agreements to LEVEL 1 transmissions thru the LEVEL 2 components of the MSII Network:
Transportation departments
Emergency management staffs
Departments of health
Police headquarters and/or stations
Fire headquarters and/or stations
Ambulance headquarters and/or stations
Public utilities headquarters and/or facilities
Schools
Hospitals
Dam authorities
Power plants and/or other power facilities
Bridge authorities
Tunnel authorities
Port police department headquarters
City managers and Council-members headquarters
Immigration and customs enforcement officials
Parks and recreational areas serving a mobile platform vehicle/temporary staging area, also doubling as a department of health headquarters to properly manage medical supply demands during particular events.

The access will be either by serving as a routing station or having access to data received from one or multiple routing stations or both. Access can be achieved by utilizing the world wide web, secure hardwire (including fiber-optic) connection, or a wireless connection (either by point to point or through the mesh-type network based on capacities utilized). It can be as simple as a direct network connection to a routing station processing data/signals.

All examples vary per region although the critical infrastructure is clearly expressed. Each agency shares connectivity rates on the MSII Network and contributes equipment (that can access existing back-up power sources when the primary power is not available). For example, certain transmitters are connected to the same battery backup source that powers the LED (light emitting diode) traffic lights. The system maximizes durability to best manage connectivity for the benefit of all infrastructures of immediate concern during emergencies. Bandwidth prioritizing for each agency's level of command can be modeled and implemented based on existing emergency response plans that have been prepared. The focus of this invention is the connectivity infrastructure to permit the transmission of signals between people/organizations/departments whenever the situation merits. The system infrastructure dynamically manages a variety of connectivity demands during various emergency conditions with varying levels of response protocols. Each expected situation (e.g., emergency condition) can be dynamically managed according to a different message routing plan to ensure the parties most affected by the situation will have the pertinent information to respond.

For example, if the situation is a fire, the local fire department receives the initial message to deploy the necessary equipment and personnel to fight the fire. During the fire, the fire department receives update messages as to the status of the fire, allowing the department head to assess conditions and determine if additional fire fighters are required. The analysis can occur at the fire department or at a fire command headquarters. Also, during the situation traffic signals receive messages for controlling the signals so that emergency vehicles can efficiently travel along the road to the fire. The local police department also receives update messages to determine whether additional police protection is required for traffic control, for example. Thus the members of the network who receive information related to the situation are dynamic and dependent on the nature of the situation and also dependent on changes in the situation over time. It is noted that according to one embodiment the network is not owned by a single government agency, but may instead be owned by a private party who licenses its use to government agencies.

The purpose of the MSII Network is to pull the many pieces of existing network connectivity infrastructure together into a larger hybrid connectivity technology platform while maximizing its capabilities. The system ensures the maximum utilization of infrastructure and operating agencies for the public's protection during a variety of emergency conditions.

### LEVEL 3 Connectivity Infrastructure

The Level 3 connectivity infrastructure encompasses any signal from LEVEL 1 or a LEVEL 2 connection thru a regional switch house to an out of local area connection, and in reverse order, directly to the end user, or indirectly as per agency interoperability agreements, regional and/or national agreements with recognition of regional connectivity needs. LEVEL 3 signals are for out-of-area transmissions, on a regional basis over secured publicly operated point-to-point wireless, dedicated fiber optical line or cable for connectivity on a regional, statewide, or multi-state wide platform. Actual areas covered by the LEVEL 3 and 4 connectivity infrastructure depend on actual conditions within those regions (physical, topographic, communication needs, threats, populations, etc.).

LEVEL 4 connectivity Infrastructure

Level 4 connectivity infrastructure encompasses any signal from the LEVELS 1-3 regional infrastructure areas to other regions through publicly operated fiber lines, cabling and/or earth-to-satellite stations. Varying levels of state and federal agencies can have access to regional data through agreements in an effort to communicate disaster recovery and Acts of God events real-time (data and video simultaneously with the communications), to reduce response time and improve the organization of resources needed in a best-effort attempt to address the logistical support and supplies that are needed.

### General Comments

Since it is intended for all network signals to pass through the network routing stations and switch houses, it is advisable to control physical access to such equipments during construction and use to guard against tampering.

In one embodiment the antennas can be used to “jump” the received signal to another antenna(s) located at some distance from the receiving antenna. For example, in a traffic control application, the receiving antenna on a road can “jump” the signal through antenna(s) mounted on either a building or another traffic signal/sign post to create the most efficient and effective method of reaching the switch. “Jumping” defines how wireless signals can reach other regions of a county without locating antennas on every road between source and destination.

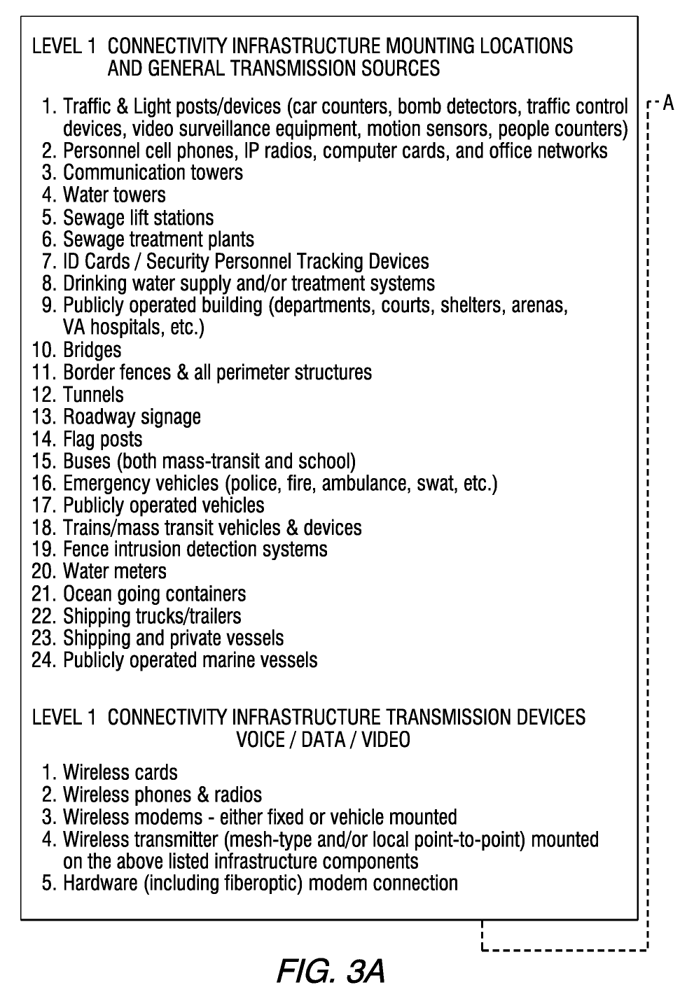

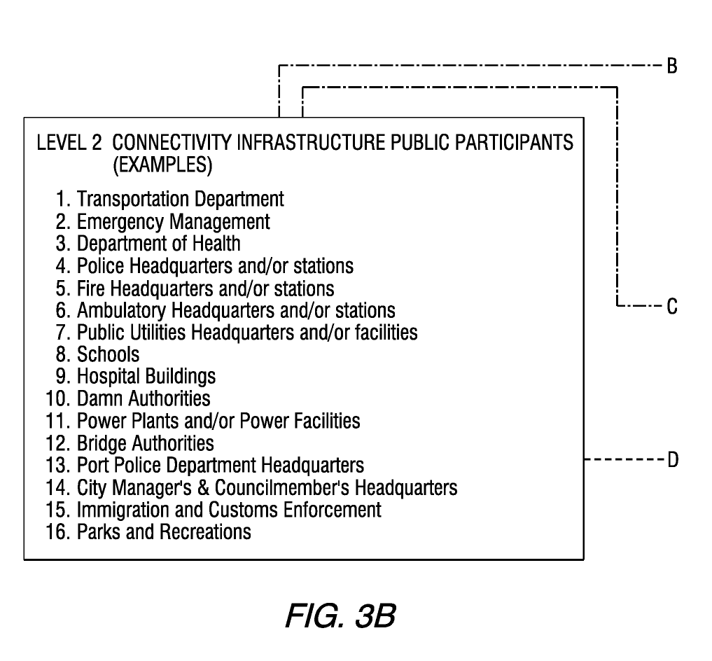

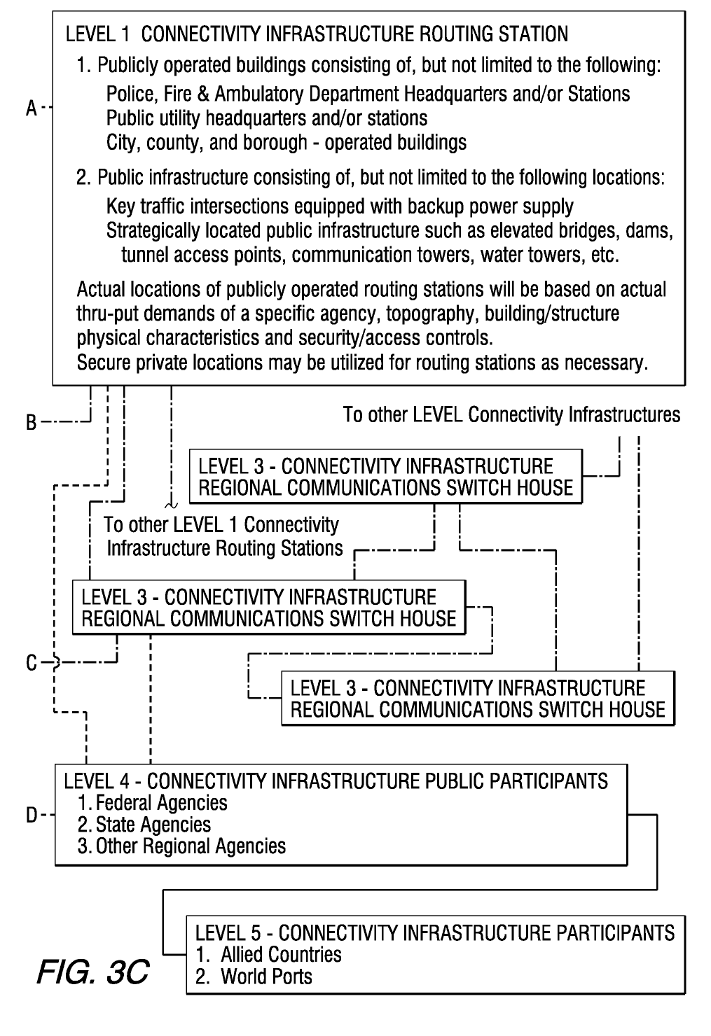

Each of the network elements is described briefly below and illustrated in the FIG. 3.

### Communications Switch

An communications switch receives inputs from the network receivers and distributes the signals to receiving users. In one embodiment one or more of the communications switches comprise an internet protocol (IP) switch. Depending on the availability of alternate communications technologies, certain segments of the MSII Network may comprise a majority of IP switches/routers.

### Intelligent Traffic System Connectivity

Transceivers are mounted on traffic posts to provide a convenient connection to a traffic control device while serving as a LEVEL 1 receiver.

### Government Buildings Connectivity

All government agency occupied buildings can be connected to the network. These connections can be implements as wireless to fiber connection points, where necessary, to maximize use of the wireless network. Thus users in these buildings can access the network using a wireless device or through the fiber network depending on the network design and the desired data transmission speed.

### Water & Wastewater Treatment Plant Connectivity

Public utilities (i.e.; sewer lift/pump stations, water supply, wastewater treatment plants, storm water management systems) will be connected to the MSII Network for monitoring and operating these plants from remote locations.

### Public Transportation Vehicles Connectivity (Including School Buses)

Buses connect to the network to synchronize their routes based on real-time coordinates with the intelligent traffic system allowing time monitors to be posted at all bus stops, which will be connected wirelessly to the network. Bus operations will be faster and more efficient, thereby promoting greater use of public transportation. Buses can either be fitted with GPS devices that relay position data to the MSII network or localized transmitters (connected to network transmitters) can be utilized to triangulate the bus's coordinates and supply the location information to the network. Once location data is relayed to an area's traffic command center, the center issues control signals to the traffic signals to control those signals as the bus travels its route.

### Sex Offender Tracking Connectivity

Localized transmitters worn by sex offenders (which are much cheaper and consume less energy than GPS devices) alert authorities of a sex offender's location, including when the offender's position breaches a protected location, such as a school or daycare center.

### Child Tracking Connectivity

Localized transmitters worn by children (much cheaper and consume less energy than a GPS device) can be used to locate a child, with the MSII Network passing signals between interested parties.

### Criminal Tracking Connectivity

Localized transmitters worn by a parolee or convicted person (or placed within his/her vehicle) can communicate with the MSII Network of the present invention to provide location information. Such a transmitter is substantially cheaper and consumes less energy than a GPS device.

### Shipping Vessels Connectivity

A communications link between container ships can be used for data transfer/confirmation prior to the ship reaching port.

### Shipping Containers Connectivity

Cheaper and more efficient than GPS transponders, localized transmitters on shipping containers can be accessed by the network and the transmitted data routed to an intended recipient.

### Emergency Vehicles Connectivity

Emergency vehicles can connect into the MSII Network as the vehicle travels on the road. This allows vehicle-mounted antennas/modems to access and manipulate the intelligent traffic system real-time consistent with the method described under Public Transportation Vehicles Connectivity above, and automatically based on the emergency vehicle's location and destination. This will significantly reduce response times. Vehicles can use this system to retrieve data/drawings to better manage emergency situations (i.e.; building plans, MSDS information for chemical plant fires/situations). To permit safe and rapid movement of emergency vehicles, the traffic signals with connection can permit the emergency vehicle to pass through signal-controlled intersections without delay or danger of interfering vehicles. A blinking green light can serve to warn the public of an emergency vehicle's approach.

### Government Agency's Wireless Communication Network

Government agencies utilizing wireless phones and wireless computer cards can utilize the network of the present invention. In particular, network access can be controlled based on user priority, such as based on rank in the event of an emergency.

### 800 MHz System Converter Connectivity

Government agencies utilizing the 800 MHz frequency can deploy a mobile base station doubling as repeaters between the two systems.

### Private Restricted ISP Connectivity

In one embodiment, depending on the relevant laws and local ordinances, the MSII network, i.e., the antenna network and communications switch, can be leased to a private entity providing ISP wireless connectivity to residents via a modem/antenna on a restricted basis. This use provides the lessor with a revenue stream while ensuring proper benchmark testing and proving the capabilities of the network.

### Back-up Communications Switch

In one embodiment the network further comprises a back-up communications switch to serve the MSII network shall the primary experience failure. This can also be achieved by utilizing other communications switches.

As can now be appreciated, the network of the present invention provides the following benefits.

National Security Benefits:
1. Connectivity to monitors and sensors mounted on traffic posts;
2. Connectivity to shipping containers, and;
3. Connectivity to shipping vessels.

U.S. Government Agency Benefits:
1. Ownership and control of a nationwide communications network;
2. Connectivity for an intelligent traffic system that can better manage evacuations, rush hour and traffic situations that impede flow;
3. Connectivity to emergency vehicles to allow for coordination of vehicle movements to traffic signals, and;
4. Source of revenue;
5. Made aware of messages related to responsibility of a government agency

Quality of Life Benefits:
1. Connectivity for an intelligent traffic system resulting in improved commute times;
2. Connectivity for a public transportation system that can be coordinated with traffic lights to reduce fuel and maintenance costs and a bus route monitor with estimated times of arrival posted at each bus stop to promote higher public transportation utilization;
3. Connectivity for emergency vehicles to the traffic system permitting faster response times to and from dire situations;
4. Connectivity for sex offender tracking;
5. Connectivity for child tracking, and
6. Increased tax revenues on a county by county basis.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described components (assemblies, devices, circuits, etc.), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more other features of the other embodiments as may be desired and advantageous for any given or particular application.

What is claimed is:

1. A communications network for making information available to a one or more government agencies, the network comprising:
antennas on publicly operated facilities;
transceivers for sending messages to and receiving messages from one or more of the antennas;
routers responsive to messages received at the antennas for routing the messages on a network path to a desired destination, the routers also responsive to messages from a source on the communications network for routing the messages to antennas; and
wherein the routers are controlled to route the messages to a desired destination, the desired destination determined by the existence of a situation involving users who can benefit from the information in the message.

2. The network of claim 1 comprising a transceiver in an emergency vehicle and antennas on a public road, as the emergency vehicle travels on the public road the transceiver in the emergency vehicle sends messages to antennas along a route of the vehicle.

3. The network of claim 1 wherein the desired destinations comprise a government agency with responsibilities related to the information in the message.

4. The network of claim 1 further comprising sensors for determining the existence of a situation and an extent of the situation.

5. The network of claim 4 wherein information related to the situation is transmitted to transceivers from the antennas and the information is provided to individuals involved in the situation.

6. The network of claim 1 wherein the desired destination comprises one of police, fire and ambulance headquarters or stations, public utility headquarters or stations, government-operated buildings, traffic intersections and public infrastructure elements.

7. The network of claim 1 wherein the publicly operated facilities comprise traffic posts, light posts, communication towers, water towers, sewage lift stations, sewage treatment plants, drinking water sources, drinking water lines and treatment plants, publicly operated buildings, bridges, border fences, tunnels, roadway signage, flag posts, buses, emergency vehicles, publicly operated vehicles, mass transit vehicles, perimeter fences, water meters, ocean going containers, shipping trucks/trailers, shipping and private vessels and publicly operated marine vessels.

8. The network of claim 1 wherein the desired destination is determined from information within the message.

9. The network of claim 1 wherein the messages comprise electrical signals or optical signals.

10. The network of claim 1 wherein the transceivers comprise publicly operated transceivers operated by users who are members of one of the government agencies.

11. The network of claim 1 wherein the situation comprises an emergency situation.

12. The network of claim 1 wherein the desired destination comprises one or more members of one or more government agencies.

13. The network of claim 1 wherein users connected to the network for receiving messages are arranged in hierarchical levels, and wherein the desired destination comprises members at a selected hierarchical level, and wherein the selected hierarchical level comprises users who can benefit from the information in the message.

14. The network of claim 13 wherein the selected hierarchical level is dependent on a security classification of the message or an urgency of the message and is further dependent on the situation.

15. The network of claim 1 wherein a government agency can control one or more routers to assign a routing path to specified recipients for messages received from specified users.

16. The network of claim 15 wherein the routing path is responsive to a current emergency situation.

17. The network of claim 1 wherein portions of the network are owned by one or more of the government agencies.

18. The network of claim 1 wherein interoperability agreements between the one or more government agencies specify specific government agencies with access to messages based on message contents.

19. The network of claim 1 wherein the plurality of routers are dynamically controlled responsive to the situation, wherein the situation comprises a sending time of the message, a manmade emergency situation or a natural emergency situation.

20. The network of claim 1 wherein the desired destination comprises one or more government agencies, and wherein an interoperability agreement between one or more government agencies specifies a destination government agency for a specific situation.

21. The network of claim 20 wherein the interoperability agreement further specifies members of the one or more government agencies for receiving the message for a specific situation.

22. The network of claim 1 wherein the message comprises an importance indicator indicating at least one of the network path and the desired destination.

23. The network of clam 22 further comprising alarms activated according to the contents of the message or according to the situation.

24. The network of claim 1 further comprising broadcast devices for alerting a segment of the public responsive to the situation.

25. The network of claim 1 wherein the destination comprises a recipient government agency, and wherein the recipient government agency determines members within the recipient government agency who are to receive the message and a time when the message is sent to the members receiving the message.

26. The network of claim 1 further comprising a device for determining a location of an emergency vehicle, and wherein the location is included with a message related to the situation.

27. The network of claim 1 wherein the destinations are determined by a dynamic routing protocol that is situation dependent and defined in interoperability agreements between the government agencies.

28. A method for managing a communications network, the method comprising:
receiving messages from one or more government agents at antennas on publicly operated facilities, wherein the messages relate to a current situation involving the one or more government agents; and
sending the messages from the antennas through routing stations to destinations at one or more government agencies, wherein the destinations are determined by details of the situation, and wherein individuals at the one or more government agencies receiving the message are determined by agreements between the one or more government agencies and by the details of the situation, and wherein the destinations and individuals at the one or more government agencies are organized in hierarchical levels with the level receiving the message determined by agreements between the one or more government agencies and by the details of the situation.
